(19) United States
(12) Patent Application Publication
(10) Pub. No.: US 2011/0093425 A1
(43) Pub. Date: Apr. 21, 2011

(54) DOCUMENT IMAGE CREATION SERVER AND PROGRAM THEREOF, AND DOCUMENT BROWSING SYSTEM

(75) Inventor: Yosuke OHASHI, Kanagawa (JP)

(73) Assignee: FUJIFILM Corporation, Tokyo (JP)

(21) Appl. No.: 12/908,515

(22) Filed: Oct. 20, 2010

(30) Foreign Application Priority Data
Oct. 21, 2009 (JP) 2009-242078

(51) Int. Cl. G06N 5/02

(52) U.S. Cl. 706/50

(57) ABSTRACT

When a document image creation server receives a browsing request of a document, a conversion section starts to create document images. A 1^{st} page of the document images which is created first is sent to a mobile phone to be browsed. When the document image creation server receives a change request of the browsing page, a prediction section predicts a browsing order of the document images based on the change request. When a browsing request of a part corresponding to N^{th} page of the document images is received, the prediction section predicts that the document images are sequentially browsed starting from the part corresponding to the N^{th} page. A conversion section converts the document, on a predetermined unit basis, into the document images in the predicted browsing order. The document image of the requested browsing page is sent to and browsed with the mobile phone.

### BACKGROUND OF THE INVENTION

1. Field of the Invention

The present invention relates to a document image creation server to create a document image to be browsed with a terminal and a program thereof, and a document browsing system which enables browsing of the document image.

2. Description of Related Art

Technological developments in a network system using thin client, which does not leave data behind on a terminal, have been promoted so as to prevent leakage of confidential information (for example, Virtual PC Center Management Software, [Online] , NEC Corporation [searched on Sep. 10, 2010] , Internet (URL: http://www.nec.com/global/solutions/vpcc/management/index.htm 1) . In the thin client, most of the processing is concentrated on a server side, and the processing executed on the terminal side is minimized.

When a document browsing request is sent from the terminal, the requested document is sequentially converted, on a predetermined unit basis, into plural images (hereinafter, referred to as “document image”). Once the whole document has been converted into plural document images, the document can be browsed with the terminal by each document image unit. When the document is browsed as the document images, the storage of the document on the terminal can be easily prohibited by security lock.

In the conventional thin client, however, the document cannot be browsed until when the conversion of the whole document into the document images is finished. Therefore, there is a problem that waiting time for browsing the document becomes longer as the size of the document increases.

If the document images are cached, the conversion into the document images can be skipped, and thereby shortening the waiting time for the browsing. For this configuration, however, large amounts of data need to be cached when the number of documents increases, which brings problems in data management.

### SUMMARY OF THE INVENTION

In view of the foregoing problems, an object of the present invention is to shorten waiting time for browsing documents with a terminal without caching, in a network system using thin client.

In order to achieve the above objects and other objects, a document image creation server of the present invention includes a conversion section, a prediction section, and a control section. The conversion section converts a document designated by a terminal, on a predetermined unit basis, into document images to be browsed with the terminal. The prediction section predicts browsing order of the document images. The control section controls the conversion section based on a prediction result of the prediction section, and makes the conversion section convert the predetermined unit of document into the document image in the predicted browsing order so as to be sequentially browsed.

It is preferable that the prediction section predicts the browsing order based on an operation status of the terminal.

The prediction section preferably predicts the browsing order as the document images are browsed in order that the document image being selected first is browsed first, based on a selection operation for selecting the document image to be browsed.

The prediction section preferably predicts the browsing order as the document images are browsed in order that the document image including a string being searched is browsed first, based on a search operation for searching the string in the document.

It is preferable that the prediction section predicts the browsing order based on a browsing history of the document image.

It is preferable that a storage section for storing a historical frequency of each document image indicating which document image followed to be browsed is further included. At this time, the prediction section predicts the browsing order as the document images are browsed in frequency ranked order in the storage section.

It is preferable that a storage section for storing a historical browsing frequency of each document image indicating how many times the document image has been browsed is further included. At this time, the prediction section predicts the browsing order as the document images are browsed in frequency ranked order in the storage section.

It is preferable that the prediction section predicts the browsing order as the document images are browsed in order that the document image having a link is followed to be browsed by linked document image, based on the link provided on the document image.

It is preferable that the prediction section predicts the browsing order based on an operation status of the terminal, a browsing history of the document image, and a link provided on the document image.

A document image creation program of the present invention enables a computer to function as a conversion section, a prediction section, and a control section. The conversion section converts a document designated by a terminal, on a predetermined unit basis, into document images to be browsed with the terminal. The prediction section predicts browsing order of the document images. The control section controls the conversion section based on a prediction result of the prediction section, and makes the conversion section convert the predetermined unit of document into the document image in the predicted browsing order so as to be sequentially browsed.

A document browsing system of the present invention includes a terminal and a document image creation server. The terminal is for browsing a designated document. The document image creation server includes a conversion section, a prediction section, and a control section. The conversion section converts a document designated by a terminal, on a predetermined unit basis, into document images to be browsed with the terminal. The prediction section predicts browsing order of the document images. The control section controls the conversion section based on a prediction result of the prediction section, and makes the conversion section convert the predetermined unit of document into the document image in the predicted browsing order so as to be sequentially browsed.

According to the present invention, the document images which are converted from the document on the predetermined unit basis are sequentially browsed. Owing to this, the waiting time for browsing can be shortened.

### BRIEF DESCRIPTION OF THE DRAWINGS

The above objects and advantages of the present invention will become more apparent from the following detailed description when read in connection with the accompanying drawings, in which:

FIG. 1 is a schematic diagram of a document browsing system;

FIG. 2 is a block diagram of a document image creation server;

FIG. 3 is a block diagram explaining a function of a CPU;

FIGS. 4A to 4F are views explaining creation processing of document images;

FIG. 5 is a flowchart explaining processing operation of the document image creation server;

FIG. 6 is a block diagram explaining a function of a CPU which performs string search;

FIG. 7 is a view illustrating a search screen of a mobile phone;

FIGS. 8A to 8F are views explaining creation processing of document images when performing the string search;

FIG. 9 is a flow chart explaining processing operation of a document image creation server which performs the string search;

FIG. 10 is an explanatory view of a browsing frequency table;

FIG. 11 is a flowchart explaining processing operation of a document image creation server which performs processing based on a browsing frequency;

FIG. 12 is an explanatory view of another browsing frequency table;

FIG. 13 is a flowchart explaining processing operation of a document image creation server which performs processing based on a browsing frequency;

FIG. 14 is a view illustrating a screen of the mobile phone for explaining a hyperlink;

FIG. 15 is a flowchart explaining processing operation of a document image creation server which performs processing based on a hyperlink; and

FIG. 16 is a flowchart explaining processing operation of a document image creation server which calculates scores on various factors.

### DESCRIPTION OF THE PREFERRED EMBODIMENTS

### First Embodiment

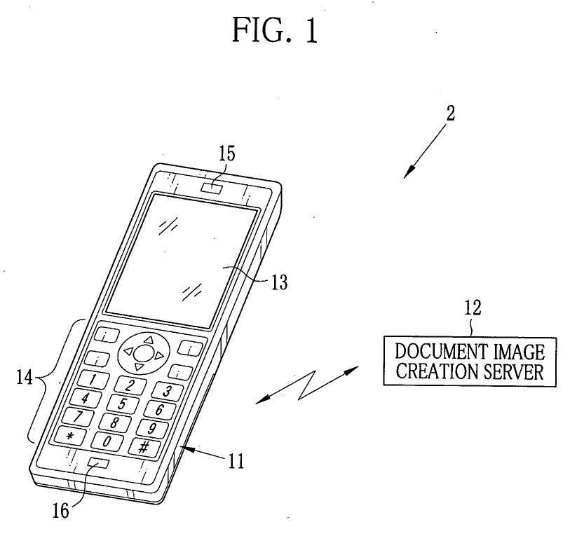

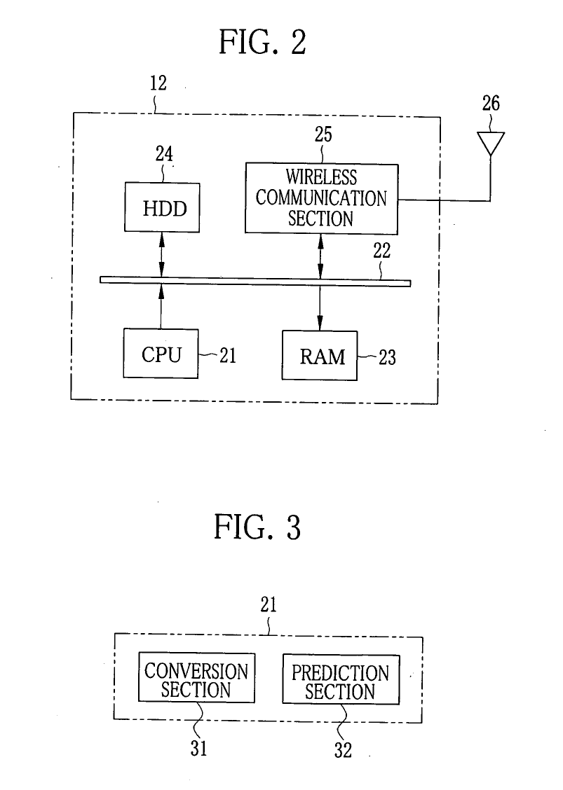

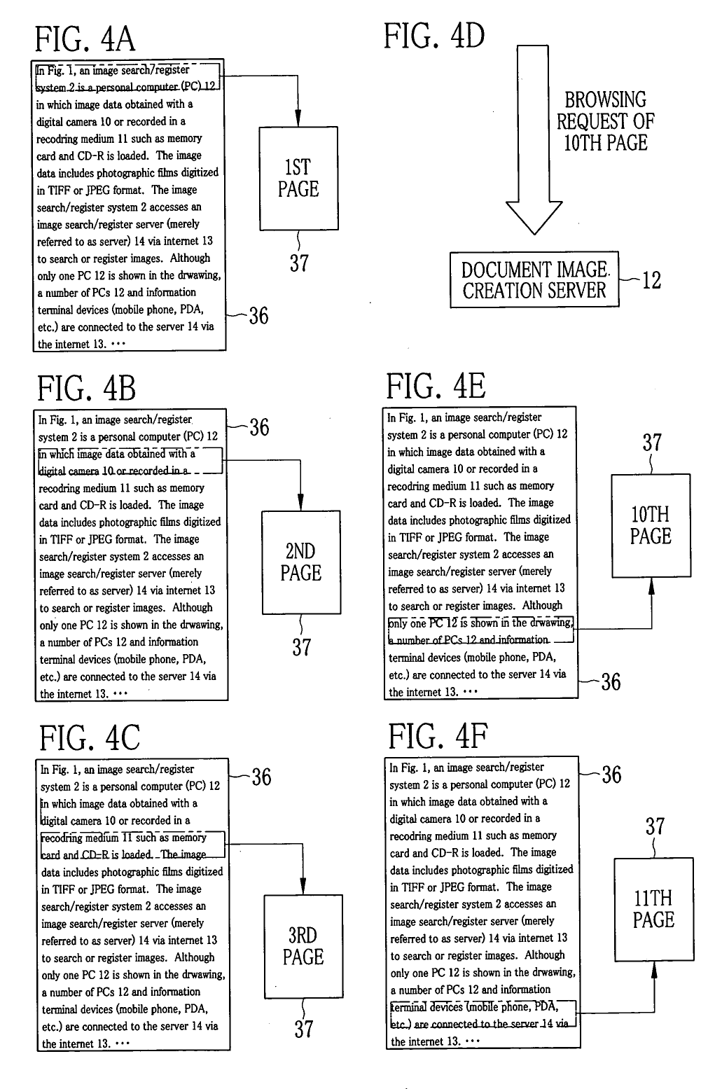

In FIG. 1, a mobile phone 11 has communication functions of telephone and internet. The mobile phone 11 is connected to a document image creation server 12 via internet. The mobile phone 11 and the document image creation server 12 construct a document browsing system 2 for browsing documents.

On a front surface of the mobile phone 11 is provided a liquid crystal display (LCD) screen 13 and an operation panel 14. The operation panel 14 is composed of a dial button for making calls and various setting buttons. A speaker 15 is provided above the LCD screen 13 and a microphone 16 is provided below the operation panel 14. The speaker 15 and the microphone 16 are connected to a telephone unit (not shown) composed of a communication circuit, a voice processing circuit and the like.

As shown in FIG. 2, the document image creation server 12 has a CPU 21. The CPU 21 controls the document image creation server 12 according to operation signals input from the operation panel 14 of the mobile phone 11. The CPU 21 is connected to a RAM 23, a hard disk drive (HDD) 24, and a wireless communication section 25 via a data bus 22.

The RAM 23 is a work memory used when various types of processing are performed by the CPU 21. The HDD 24 stores various programs for operating the document image creation server 12, documents 36 which are browsed with the mobile terminal 11 (see FIGS. 4A to 4F) , and other data. The CPU 21 reads out the programs from the HDD 24 and deploys them on the RAM 23. The CPU 21 then sequentially executes the programs. The wireless communication section 25 communicates with the mobile phone 11 via an antenna 26.

As shown in FIG. 3, a conversion section 31 and a prediction section 32 are built in the CPU 21 owing to the execution of the program. The conversion section 31 reads out the document 36 which is designated by the mobile phone 11 from the HDD 24 and converts it into document images 37 (see FIGS. 4A to 4F).

If the document 36 is longer than a predetermined unit (for example, 15 two-byte characters×20 lines), the conversion section 31 converts the document 36, on the predetermined unit basis from the beginning thereof, into the document images 37. The prediction section 32 predicts an order in which the document images 37 are browsed with the mobile phone 11 (browsing order) based on a browsing request from the mobile phone 11. If the browsing request is sent from the mobile phone 11, the conversion section 31 sequentially converts the document 36 into the document images 37 in the browsing order predicted by the prediction section 32.

Specifically, the conversion section 31 converts the document 36 into the document images 37 by the predetermined unit such as a 1^{st} page shown in FIG. 4A, a 2^{nd} page shown in FIG. 4B, and a 3^{rd} page shown in FIG. 4C. If the document image creation server 12 receives the browsing request of the part corresponding to a 10^{th} page of the document 36 as shown in FIG. 4D, the prediction section 32 predicts that the document images 37 are sequentially browsed from the part corresponding to the 10^{th} page of the document 36. The conversion section 31 sequentially converts into the 10^{th} page, followed by 11^{th} page, each of the rest of the pages, and 4^{th} page to 9^{th} page of the document images 37.

The 1^{st} page of the converted document image 37 is automatically sent to the mobile phone 11 first. Then, each of the following pages is sequentially sent to the mobile phone 11 according to the browsing request. Thus, one page (predetermined unit) of the document image 37 is displayed on the LCD screen 13 of the mobile phone 11 to be browsed.

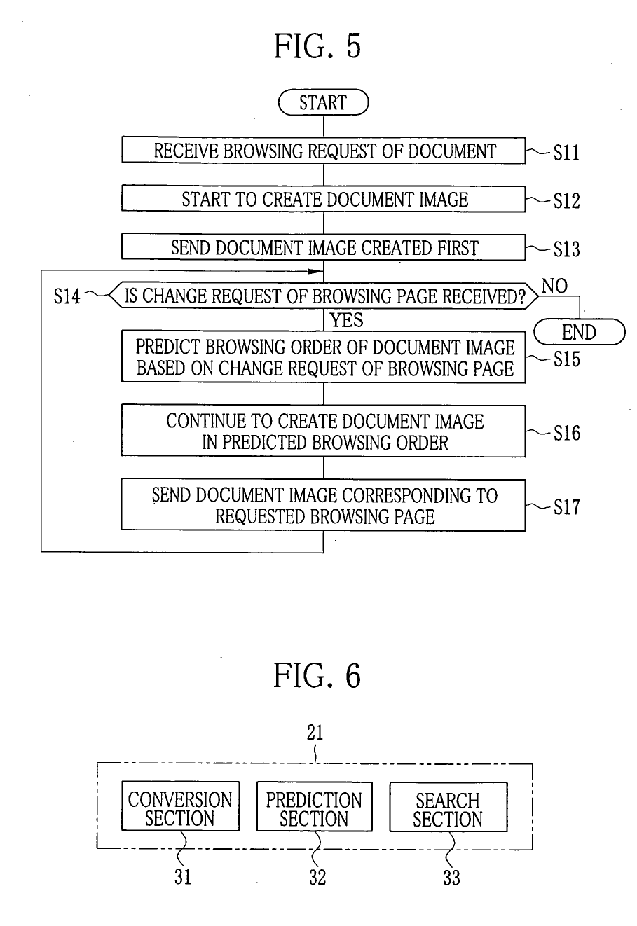

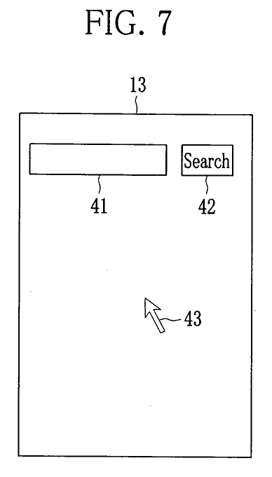

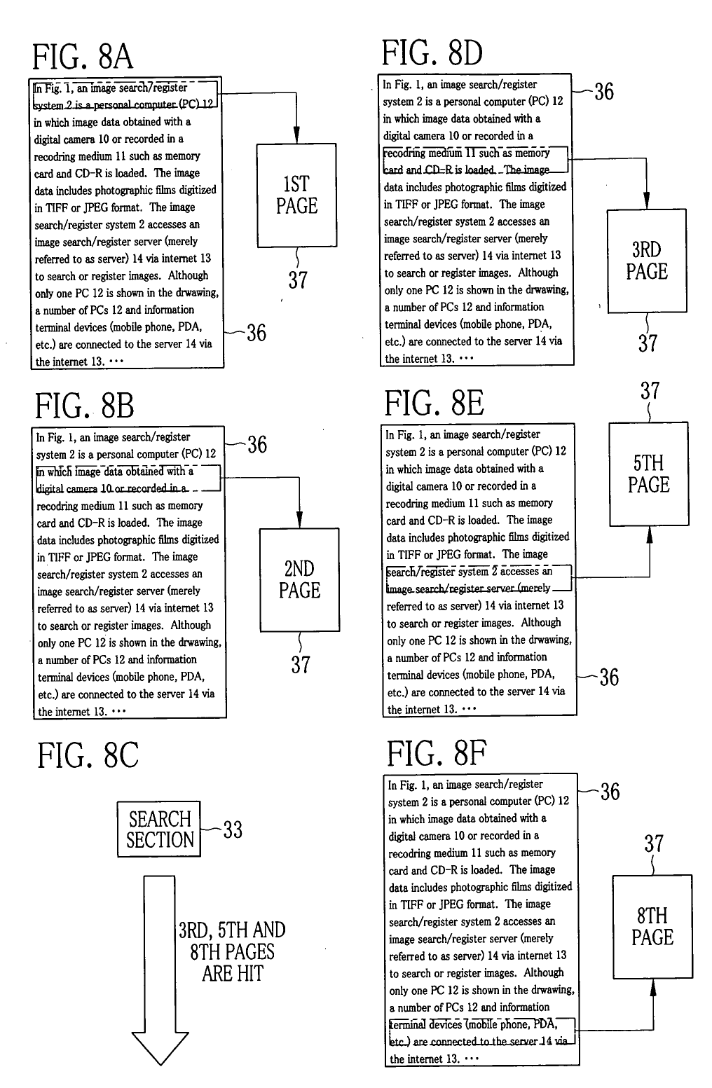

Hereinafter, processing procedures for creating the document images 37 in the document image creation server 12 is explained with reference to the flowchart of FIG. 5. Note that the case where plural document images 37 are created from the designated document 36 is explained.

When the document 36 to be browsed is designated by the operation of the operation panel 14 of the mobile phone 11, the browsing request of the document 36 is sent from the mobile phone 11. When the document image creation server 12 receives the browsing request of the document 36 (step (hereinafter abbreviated to “S”) 11), the conversion section 31 starts to create the document images 37 (S12). The 1^{st} page of the document image 37 which is created first is sent to the mobile phone (S13), and thus browsed with the mobile phone 11.

When the page to be browsed is designated by the operation of the operation panel 14 of the mobile phone 11, a change request of the browsing page is sent from the mobile phone 11. When the document image creation server 12 receives the change request of the browsing page (YES at S14), the prediction section 32 predicts the browsing order of the document images 37 based on the change request of the browsing page (S15). The conversion section 31 continues to create the document images 37 in the predicted browsing order (S16). The document image 37 corresponding to the requested browsing page is sent to the mobile phone 11 (S17) , and thus browsed with the mobile phone 11.

In this way, the part of the document 36 converted into the document image 37 can be sequentially browsed. Therefore, the waiting time for browsing is shortened as compared to the case where the browsing cannot be started until when the conversion of the whole document 36 into the document images 37 is finished. In addition, since the conversion into the document images 37 is performed after the prediction of the browsing order of the document images 37 based on the operation status of the mobile phone 11, the part which may highly be browsed next can be converted into the document image 37 in advance. Owing to this, the risk in which the part to be browsed is not converted into the document image 37 is lowered, and thereby shorting the total waiting time for browsing.

### Second Embodiment

In this embodiment, the prediction of the browsing order of the document images 37 is based a result of string search. As shown in FIG. 6, a search section 33 is built as well as the conversion section 31 and the prediction section 32 in the CPU 21.

Once the search section 33 is built in the CPU 21, a search field 41 and a search button 42 are arranged on the LCD screen 13 of the mobile phone 11. The search filed 41 is for entering a search string. The search button 42 is for executing search of the search string entered in the search field 41.

A cursor 43 used for the selection operation is displayed on the LCD screen 13. The cursor 43 moves on the LCD screen 13 by the operation of the operation panel 14.

When the cursor 43 is clicked on the search field 41, the search string is allowed to be entered. When the cursor 43 is clicked on the search button 42 after the entry of the search string in the search field 41, the entered search string is sent to the document image creation server 12.

Once the search string is entered from the mobile phone 11, the search section 33 searches a part, which includes the string entered, in the designated document 36. The prediction section 32 predicts an order in which the document images 37 are browsed with the mobile phone 11 (browsing order) based on a result of the string search. If the search string is entered from the mobile phone 11, the conversion section 31 sequentially converts the document 36 into the document images 37 in the browsing order predicted by the prediction section 32.

Specifically, the conversion section 31 converts the document 36 into the document images 37 by the predetermined unit such as a 1^{st} page shown in FIG. 8A and a 2^{nd} page shown in FIG. 8B. If the parts corresponding to 3^{rd}, 5^{th} and 8^{th} pages of the document 36 hit on the string search by the search section 33 as shown in FIG. 8C, the prediction section 32 predicts that the document images 37 are sequentially browsed from the part corresponding to the 3^{rd}, 5^{th} and 8^{th} pages of the document 36. Then conversion section 31 sequentially converts into the 3^{rd} page, followed by the 5^{th} and 8^{th} pages, and by each of 2^{nd}, 4^{th}, 6^{th}, 7^{th} and 9^{th} pages.

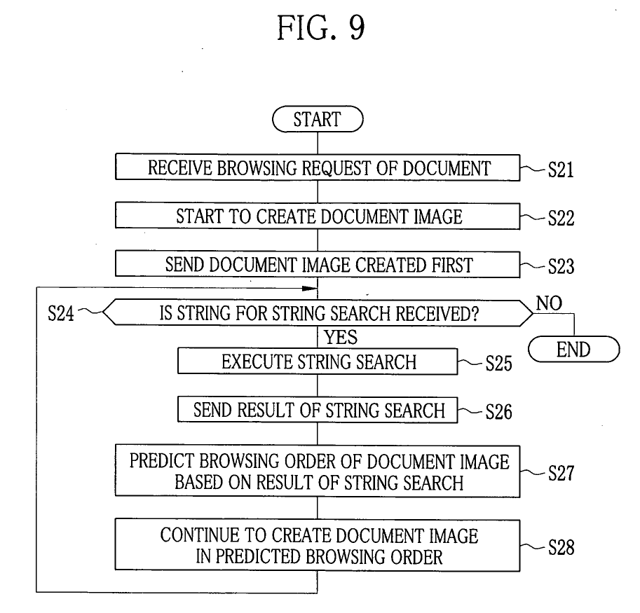

Hereinafter, processing procedures according to this embodiment are explained with reference to the flowchart of FIG. 9. Steps S21 to S23 are same as the steps S11 to S13, and the 1^{st} page of the document image 37 which is created first by the conversion section 31 is browsed with the mobile phone 11.

When the search string is entered by the operation of the operation panel 14 of the mobile phone 11, the document image creation server 12 receives the search string (YES at S24). The search section 33 executes string search (S25). The result of the string search is sent to the mobile phone 11 (S26) and displayed on the LCD screen 13 of the mobile phone 11. In addition, the prediction section 32 predicts the browsing order of the document images 37 based on the search result (S27). The conversion section 31 continues to create the document images 37 in the predicted browsing order (S28). Note that explanation for the configurations, operations, and effects same as the first embodiment is omitted. In the following embodiments, only the points different from the other embodiments are explained.

### Third Embodiment

In this embodiment, the prediction of the browsing order of the document images 37 is based on a historical frequency indicating which document image 37 is browsed next to which document image 37.

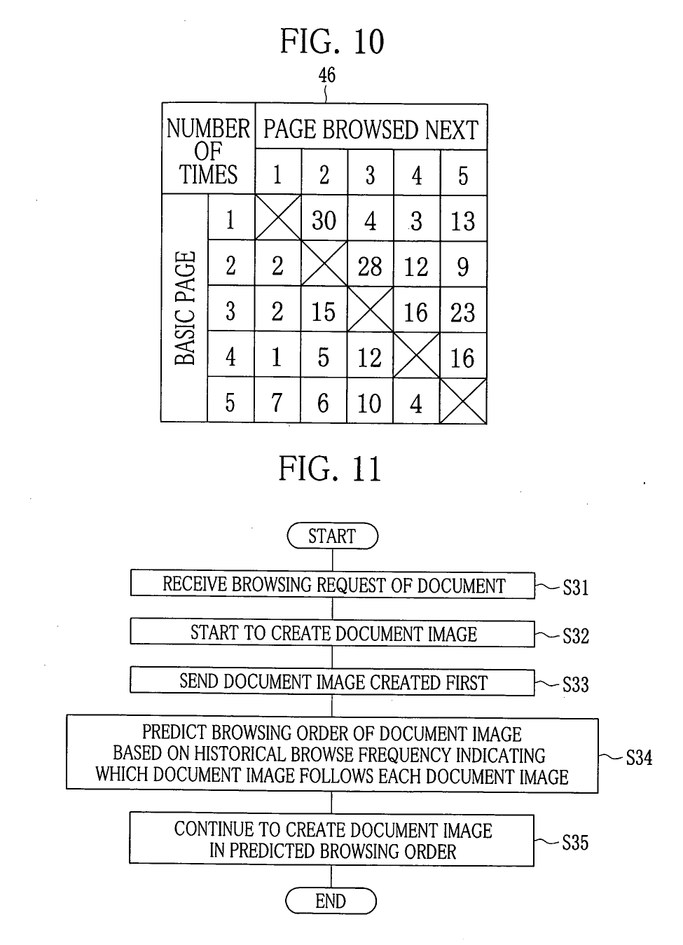

The HDD 24 stores a browsing frequency table 46 as shown in FIG. 10 for each document 36. On the browsing frequency table 46, a historical browsing frequency indicating which document image 37 followed, that is, was browsed next to each document image 37 is recorded. For example, the number of times the 2^{nd} page was browsed next to the 1^{st} page is 30 times, and the number of times the 3^{rd} page was browsed net to the 4^{th} page is 12 times.

The prediction section 32 predicts an order in which the document images 37 are browsed with the mobile phone 11 (browsing order) based on the historical browsing frequency recorded on the browsing frequency table 46. Note that, however, a 1^{st} page is predicted as being browsed first. In addition, the pages which have already been extracted to be browsed are eliminated for the prediction.

In the case shown in FIG. 10, the page to be browsed next to the 1^{st} page is predicted to be the 2^{nd} page which has highest frequency of 30 times of following the 1^{st} page. While eliminating the 1^{st} page, the page to be browsed next to the 2^{nd} page is predicted to be the 3^{rd} page which has highest frequency of 28 times of following the 2^{nd} page. While eliminating the 1^{st} and 2^{nd} pages, the page to be browsed next to the 3^{rd} page is predicted to be the 5^{th} page which has highest frequency of 23 times of following the 3^{rd} page. While eliminating the 1^{st} 2^{nd}, and 3^{rd} pages, the page to be browsed next to the 5^{th} page is predicted to be the 4^{th} page which has highest frequency of 4 times of following the 5^{th} page. I this way, the prediction section 32 predicts the browsing order to be 1^{st}, 2^{nd}, 3^{rd}, 5^{th}, and 4^{th} pages.

If the document 36 to be browsed is designated by the mobile phone 11, the conversion section 31 sequentially converts the document 36 into the document images 37 in the browsing order predicted by the prediction section 32.

Hereinafter, processing procedures according to this embodiment are explained with reference to the flowchart of FIG. 11. Steps S31 to S33 are same as the steps S11 to S13, and the 1^{st} page of the document image 37 which is created first by the conversion section 31 is browsed with the mobile phone 11.

The prediction section 32 predicts the browsing order of the document images 37 based on the historical browsing frequency recorded on the browsing frequency table 46 (S34) . The conversion section 31 continues to create the document images 37 in the predicted browsing order (S35).

### Fourth Embodiment

In this embodiment, the prediction of the browsing order of the document images 37 is based on a historical frequency indicating how many times each document image 37 was browsed.

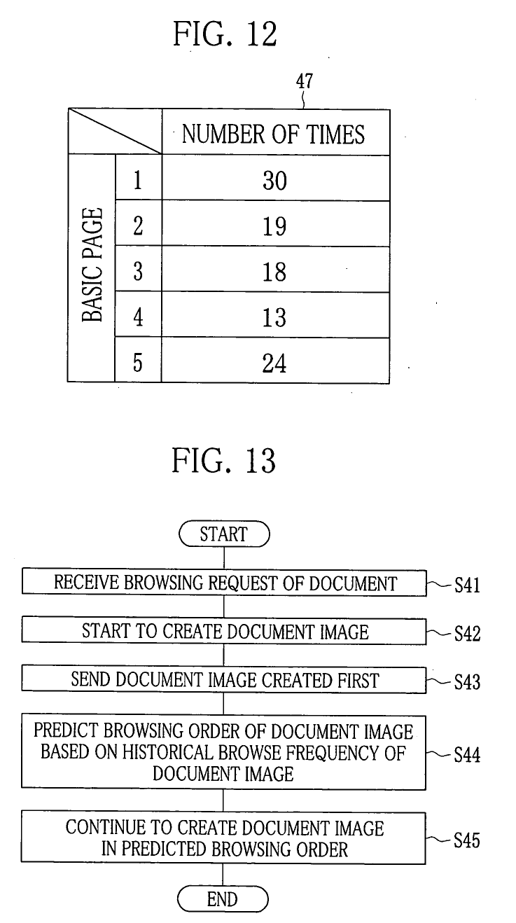

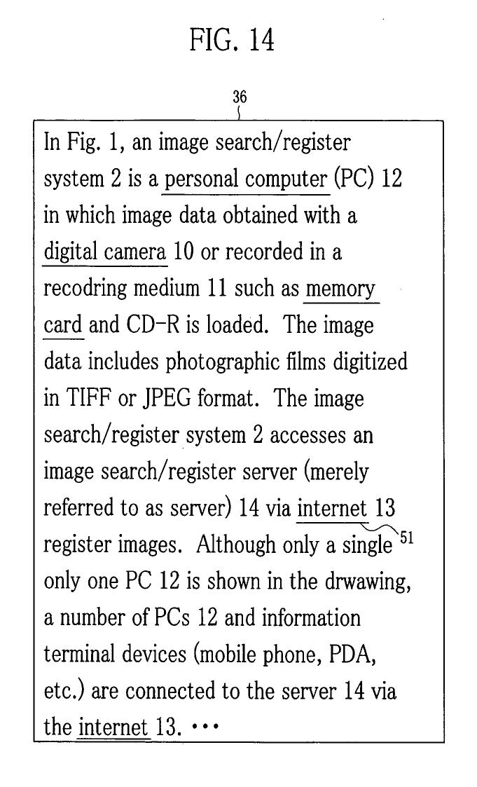

The HDD 24 stores a browsing frequency table 47 as shown in FIG. 12 for each document 36. On the browsing frequency table 47, a historical browsing frequency indicating how many times each document image 37 was browsed is recorded. For example, the number of times the 2^{nd} page was browsed is 19 times, and the number of times the 4^{th} page was browsed is 13 times.

In the case shown in FIG. 12, the prediction section 32 predicts the browsing order as frequency ranked order. That is, starting with the 1^{st} page, followed by the 5^{th} page with the browsed frequency of 24 times, the 2^{nd} page with the browsed frequency of 19 times, the 3^{rd} page with the browsed frequency of 18 times, and the 4^{th} page with the browsed frequency of 13 times.

Hereinafter, processing procedures according to this embodiment are explained with reference to the flowchart of FIG. 11. Steps S41 to S43 are same as the steps S31 to S33, and the 1^{st} page of the document image 37 which is created first by the conversion section 31 is browsed with the mobile phone 11.

The prediction section 32 predicts the browsing order of the document images 37 based on the historical browsing frequency recorded on the browsing frequency table 47 (S44). The conversion section 31 continues to create the document images 37 in the predicted browsing order (S45).

### Fifth Embodiment

In this embodiment, the prediction of the browsing order of the document images 37 is based on a link provided on the document 36.

As shown in FIG. 14, the document 36 is provided with several links 51. The link 51 includes a linked address. When the link 51 as the document image 37 is displayed on the LCD screen 13 of the mobile phone 11, the document image 37 that the link 51 represents can be browsed by clicking the link 51 with the cursor 42 thereon.

The prediction section 32 predicts an order in which the document images 37 are browsed with the mobile phone 11 (browsing order) based on the links 51 provided on the document 36. Specifically, if the link 51 provided on the 1^{st} page represents the 4^{th} page, the prediction section 32 predicts that the 4^{th} page is browsed next to the 1^{st} page. The links 51 provided on the 4^{th} page represent the 2^{nd} and 5^{th} pages, the prediction section 32 predicts that the 2^{nd} and 5^{th} pages are browsed next to the 4^{th} page. The links 51 provided on the 2^{nd} and 5^{th} pages represent the 3^{rd} and 6^{th} pages, the prediction section 32 predicts that the 3^{rd} and 6^{th} pages are browsed next to the 2^{nd} and 5^{th} pages. Thus, the prediction section 32 predicts the browsing order as the 1^{st} page first, followed by the 4^{th}, 2^{nd}, 5^{th}, 3^{rd}, and 6^{th} pages.

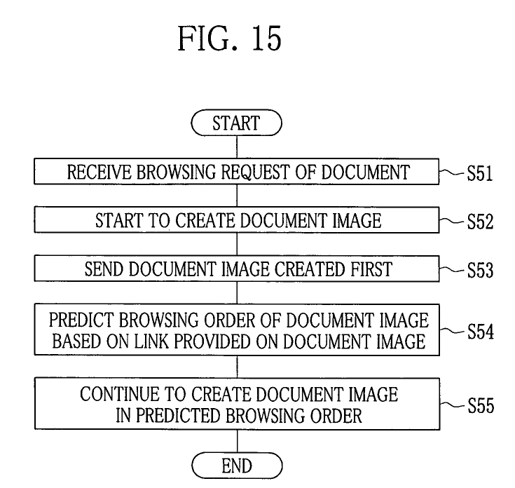

Hereinafter, processing procedures according to this embodiment are explained with reference to the flowchart of FIG. 15. Steps S51 to S53 are same as the steps S11 to S13, and the 1^{st} page of the document image 37 which is created first by the conversion section 31 is browsed with the mobile phone 11.

The prediction section 32 predicts the browsing order of the document images 37 based on the links 51 provided on the document 36 (S54). The conversion section 31 continues to create the document images 37 in the predicted browsing order (S55).

### Sixth Embodiment

Note that the configurations of the first to fifth embodiments are applicable to one another, and the prediction section 32 may perform the prediction based on the overall judgment of various factors. In this embodiment, the prediction of the browsing order of the document images 37 is based on scores calculated by the various factors.

The HDD 24 stores the browsing frequency table 46 as shown in FIG. 10 and the browsing frequency table 47 as shown in FIG. 12.

Based on the result of the string search, the browsing order of the document images 37, the links 51 provided on the document 36, and the historical browsing frequencies recorded on the browsing frequency tables 46, 47, the prediction section 32 calculates a score of each document image 37 for each of the above factors. The prediction section 32 predicts that the document images 37 are browsed in decreasing order of score.

The score based on the result of the string search is given to the document image 37 corresponding to the part hit on the search. The score is calculated by the following equation:

score={(the number of pages counted from the presently browsed document image 37 to the farthest document image 37 among the document images 37 corresponding to the part hit on the search)−(the number of pages counted from the presently browsed document image 37 to the corresponding document image 37)}/(the number of pages counted from the presently browsed document image 37 to the farthest document image 37 among the document images 37 corresponding to the part hit on the search)×100

wherein the closer to the presently browsed document image 37, the higher score the document image 37 can get.

If continuous two pages of document images 37 are sequentially browsed, the score based on the browsing order of the document image 37 is given only to the following page of the document image 37. The score is calculated by the following equation:

score={(last page of the document image 37)−(page of the corresponding document image 37)}/{(last page of the document image 37)−(page of the presently browsed document image 37)}×100

wherein the closer to the presently browsed document image 37, the higher score the document image 37 can get.

The score based on the links 51 provided on the document image 37 is given only to the document image 37 represented by the link 51 on the presently browsed document image 37. The score is calculated by the following equation:

score={(the number of the document images 37 represented by the links 51 provided on the presently browsed document image 37)−(the rank of the corresponding document image 37 in closeness to the presently browsed document image 37 among the document images 37 represented by the links 51 on the presently browsed document image 37)}/(the number of the document images 37 represented by the links 51 provided on the presently browsed document image 37)×100

wherein the closer to the presently browsed document image 37, the higher score the document image 37 can get.

The score based on the historical browsing frequency recorded on the browsing frequency table 46 is given only to the document images 37 which were browsed next to the presently browsed document image 37. The score is calculated by the following equation:

score=(the number of times the corresponding document image 37 was browsed next to the presently browsed document image 37)/(sum of the number of times each document image 37 was browsed next to the presently browsed document image 37)×10

wherein the higher number of times the document image 37 was browsed next to the presently browsed document image 37, the higher score the document image 37 can get.

The score based on the historical browsing frequency recorded on the browsing frequency table 47 is given only to the document images 37 which were browsed before. The score is calculated by the following equation:

score=(the number of times the corresponding document image 37 was browsed)/(sum of the number of times each document image 37 was browsed)×10

wherein the higher number of times the document image 37 was browsed, the higher score the document image 37 can get.

In the calculation of the score based on the result of the string search, the browsing order of the document image 37, and the link 51 provided on the document 36, “100” is multiplied as a weight coefficient. In the calculation of the score based on the historical browsing frequencies recorded on the browsing frequency tables 46, 47, “10” is multiplied as a weight coefficient. According to this method, the score variation owing to the browsing frequency can be prevented, and the score can be obtained even when the scores cannot be obtained on the factors besides the browsing frequencies.

If the document 36 to be browsed is designated by the mobile phone 11, or if the search string is entered from the mobile phone 11, or if the browsing requests of continuous two pages of document images 37 are sequentially sent from the mobile phone 11, the document 36 is sequentially converted into the document images 37 in the browsing order predicted by the prediction section 32.

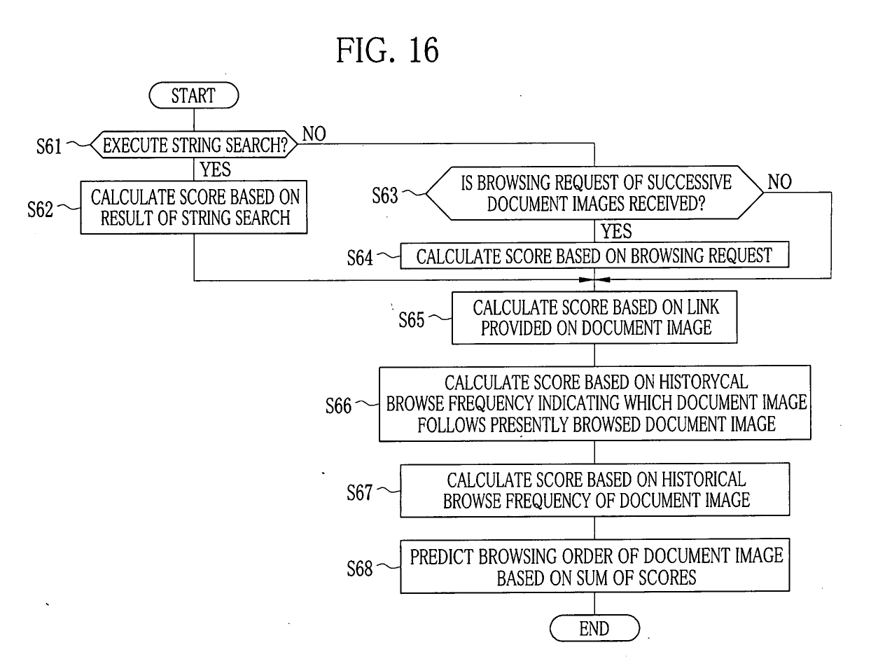

Hereinafter, processing procedures for predicting the browsing order of the document images 37 is explained with reference to the flowchart of FIG. 16.

When the search section 33 executes string search (YES at S61), the prediction section 32 calculates score based on the search result (S62) . Meanwhile, when the document image creation server 12 receives the browsing requests of the continuous document images 37 (YES at S63), the prediction section 32 calculates score based on the browsing requests (S64).

The prediction section 32 calculates score based on the links 51 provided on the document image 37 which is presently being browsed (S65). In addition, the prediction section 32 calculates score based on the historical browsing frequency indicating which document image 37 was browsed next to the presently browsed document image 37 (S66). Moreover, the prediction section 32 calculates score based on the historical browsing frequency indicating how many times the presently browsed document image 37 was browsed before (S67).

Furthermore, the prediction section 32 predicts the browsing order of the document images 37 based on a sum of the calculated scores (S68).

Thus, the browsing order of the document images 37 is predicted based on the scores calculated on various factors. Owing to this, the prediction accuracy is improved and the risk in which the part to be browsed is not converted into the document image 37 is lowered.

In the above embodiments, the case where the document browsing system 2 is constituted of the mobile phone 11 is explained. However, the terminal used is not limited to the mobile phone 11, and may be any other communication terminals having a monitor, such as a notebook computer or a mobile game device.

Various changes and modifications are possible in the present invention and may be understood to be within the present invention.

What is claimed is:

1. A document image creation server, comprising:
a conversion section for converting a document designated by a terminal, on a predetermined unit basis, into document images to be browsed with said terminal;
a prediction section for predicting browsing order of said document images; and
a control section for controlling said conversion section based on a prediction result of said prediction section, and making said conversion section convert said predetermined unit of said document into said document image in the predicted browsing order so as to be sequentially browsed.

2. The document image creation server as defined in claim 1, wherein said prediction section predicts said browsing order based on an operation status of said terminal.

3. The document image creation server as defined in claim 2, wherein said prediction section predicts said browsing order as said document images are browsed in order that said document image being selected first is browsed first, based on a selection operation for selecting said document image to be browsed.

4. The document image creation server as defined in claim 2, wherein said prediction section predicts said browsing order as said document images are browsed in order that said document image including a string being searched is browsed first, based on a search operation for searching said string in said document.

5. The document image creation server as defined in claim 1, wherein said prediction section predicts said browsing order based on a browsing history of said document image.

6. The document image creation server as defined in claim 5, further comprising a storage section for storing a historical frequency of each document image indicating which said document image followed to be browsed, wherein said prediction section predicts said browsing order as said document images are browsed in frequency ranked order in said storage section.

7. The document image creation server as defined in claim 5, further comprising a storage section for storing a historical browsing frequency of each document image indicating how many times said document image has been browsed, wherein said prediction section predicts said browsing order as said document images are browsed in frequency ranked order in said storage section.

8. The document image creation server as defined in claim 1, wherein said prediction section predicts said browsing order as said document images are browsed in order that said document image having a link is followed to be browsed by linked said document image, based on said link provided on said document image.

9. The document image creation server as defined in claim 1, wherein said prediction section predicts said browsing order based on an operation status of said terminal, a browsing history of said document image, and a link provided on said document image.

10. A document image creation program enabling a computer to function as:
a conversion section for converting a document designated by a terminal, on a predetermined unit basis, into document images to be browsed with said terminal;
a prediction section for predicting browsing order of said document images; and
a control section for controlling said conversion section based on a prediction result of said prediction section, and making said conversion section convert said predetermined unit of said document into said document image in the predicted browsing order so as to be sequentially browsed.

11. A document browsing system, comprising:
(A) a terminal for browsing a designated document; and
(B) a document image creation server, including:
a conversion section for converting a document designated by a terminal, on a predetermined unit basis, into document images to be browsed with said terminal;
a prediction section for predicting browsing order of said document images; and
a control section for controlling said conversion section based on a prediction result of said prediction section, and making said conversion section convert said predetermined unit of said document into said document image in the predicted browsing order so as to be sequentially browsed.
